(19) United States
(12) Patent Application Publication
(10) Pub. No.: US 2004/0102250 A1
(43) Pub. Date: May 27, 2004

(54) Gaming machine button tapper and method therefor

(76) Inventor: Catherine J. Coley, Las Vegas, NV (US)

Correspondence Address: WEISS & MOY PC, 4204 NORTH BROWN AVENUE, SCOTTSDALE, AZ, 85251, US

(21) Appl. No.: 10/300,140

(22) Filed: Nov. 21, 2002

(51) Int. Cl. A63F 9/24; A63F 13/00; G06F 17/00; G06F 19/00

(52) U.S. Cl. 463/47

(57) ABSTRACT

A gaming machine button tapper having a handle portion, a substantially L-shaped member coupled to the handle portion and a downwardly protruding member coupled to the substantially L-shaped member and dimensioned to tap a gaming machine button. The gaming machine button tapper allows a person to tap the play button of a gaming machine quickly while at the same time easing the strain normally placed on a person's body when leaning forward to tap a gaming machine button.

### FIELD OF THE INVENTION

This invention relates generally to gaming machine devices and, more specifically, to a gaming machine button tapper capable of allowing a person to tap a gaming machine button from a distance.

### BACKGROUND OF THE INVENTION

Gaming machines, such as slot machines and video poker machines, account for a majority of all gaming revenues in the State of Nevada. This popular form of gambling and entertainment requires a person to activate a gaming machine, generally by either pulling a handle or, more commonly, pushing a button.

Most gaming machines are placed on an elevated platform with a row of seats facing the gaming machines. Players will often sit in one of the seats, playing the gaming machine for large amounts of time. Players play for fun, to win money, to play in a slot machine tournament, or for any or all of these reasons. The faster that a person can tap the “play” button initiating the game, the more games a player can play during a set period of time. During gaming machine tournaments in particular, the difference between winning and losing can often come down to the number of extra plays that one player has over another player.

For this and other reasons, players often keep an arm outstretched with a hand directly over the “play” button in order to continuously tap the button with their fingers. This physical position, which often requires a player to lean forward, puts stress on the joints of a person's shoulder, elbow, and wrist, and also places strain on a person's lower back.

A need therefore existed for a gaming machine button tapper capable of allowing a person to tap the play button of a gaming machine quickly while at the same time easing the physical strain that is normally associated with tapping a gaming machine button in the conventional way.

### SUMMARY OF THE INVENTION

An object of the present invention is to provide a gaming machine button tapper capable of allowing a person to continuously tap the play button of a gaming machine without undue strain on a person's body.

It is a further object of the present invention to provide a method for playing a gaming machine allowing for ease and comfort while playing a gaming machine.

### BRIEF DESCRIPTION OF THE PREFERRED EMBODIMENTS

In accordance with one embodiment of the present invention, a gaming machine button tapper is disclosed, comprising, in combination, a handle portion, and a substantially L-shaped member coupled to the handle portion, the substantially L-shaped member having a downwardly protruding portion dimensioned to tap a slot machine button.

In accordance with another embodiment of the present invention, a method for playing a gaming machine is disclosed, comprising, in combination, the steps of providing a handle portion, providing a substantially L-shaped member coupled to the handle portion, the substantially L-shaped member having a downwardly protruding portion, gripping the handle portion, and tapping a gaming machine button with the downwardly protruding portion.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of the preferred embodiment of the gaming machine button tapper of the present invention, showing a person using the tapper to tap a button on a gaming machine.

FIG. 2 is a perspective view of the gaming machine button tapper of the present invention.

FIG. 3 is a bottom view of the gaming machine button taper of FIG. 2.

FIG. 4 is a side, cross-sectional view of the downwardly protruding portion of the gaming machine button tapper of FIG. 3, taken along line 4-4.

FIG. 5 is a perspective view of an alternative embodiment of the gaming machine button tapper, showing a downwardly protruding portion having a substantially flat end.

### DETAILED DESCRIPTION OF THE PREFERRED EMBODIMENTS

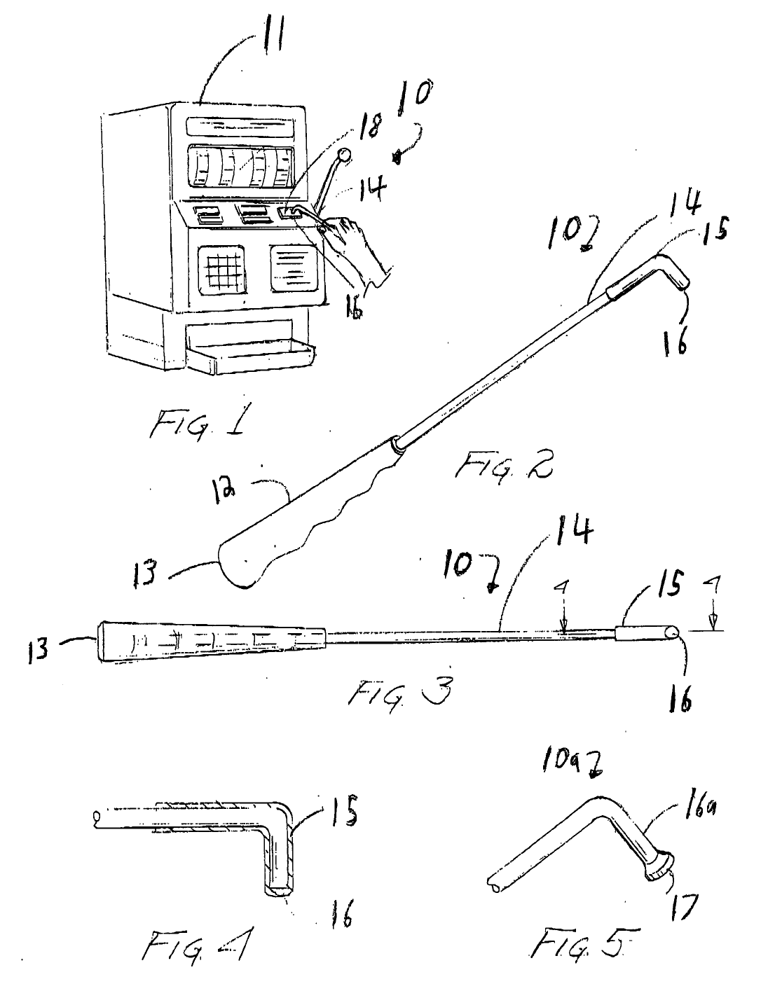

Referring now to FIGS. 1-3 reference number 10 refers generally to the gaming machine button tapper of the present invention. The gaming machine button tapper 10 comprises a handle portion 12 (shown in FIGS. 1-2) and a substantially L-shaped member 14 coupled to the handle portion 12. The substantially L-shaped member 14 has a downwardly protruding portion 16 dimensioned to tap a gaming machine button 18 (shown in FIG. 1).

In the preferred embodiment, the downwardly protruding portion 16 comprises an outer surface having a shock-absorbent material 15 (shown in FIGS. 2-4), preferably rubber, although it should be clearly understood that substantial benefit could be derived from an alternative configuration of the gaming machine button tapper 10 in which no shock-absorbent material is used or a shock-absorbent material other than rubber is used.

In the preferred embodiment, the distance from an end portion 13 (shown in FIGS. 2-3) of the handle portion 12 to the downwardly protruding portion 16 is approximately 10 inches, although it should be clear that substantial benefit could be derived from an alternative embodiment of the present invention in which the distance between the end portion 13 and the downwardly protruding portion 16 deviates, even substantially, from the preferred distance in either direction.

Referring now to FIG. 5, an alternative embodiment of the gaming machine button tapper 10, hereinafter 10a, is shown. The gaming machine button tapper 10a comprises a downwardly protruding portion 16 having a substantially flat end portion 17. The purpose of the substantially flat end portion 17 is to increase the surface area of the contact area of the downwardly protruding portion 16. While, in this alternative embodiment, the gaming machine button tapper 10a has a downwardly protruding portion 16 having a substantially flat end portion 17, it should be clearly understood that substantial benefit could be derived from either the preferred embodiment, or yet another alternative embodiment of the gaming machine button tapper 10a in which the downwardly protruding portion 16 comprises a different configuration.

### Statement of Operation

In order to use to the gaming machine button tapper 10 one first faces a gaming machine 11 (shown in FIG. 1) in either a seated or standing position. Then, one grips the gaming machine button tapper 10 by the handle portion 12 (as shown in FIG. 1) with the downwardly protruding portion 16 of substantially L-shaped member 14 facing down towards the button 18 of a gaming machine 11. A player then taps the button 18 with the gaming machine button tapper 10, with the downwardly protruding portion 16 making contact with the button 18.

While the invention has been particularly shown and described with reference to preferred embodiments thereof, it will be understood by those skilled in the art that the foregoing and other changes in form and details may be made therein without departing from the spirit and scope of the invention.

I claim:

1. A gaming machine button tapper comprising, in combination:
a handle portion; and
a substantially L-shaped member coupled to said handle portion, said substantially L-shaped member having a downwardly protruding portion dimensioned to tap a gaming machine button.

2. The gaming machine button tapper of claim 1 wherein said downwardly protruding portion comprises an outer surface having a shock-absorbent material.

3. The gaming machine button tapper of claim 2 wherein said shock-absorbent material is rubber.

4. The gaming machine button tapper of claim 1 wherein a distance from an end portion of said handle portion to said downwardly protruding portion is approximately 10 inches.

5. The gaming machine button tapper of claim 1 wherein said downwardly protruding portion comprises a substantially flat end portion.

6. A method for playing a gaming machine comprising, in combination;
providing a handle portion;
providing a substantially L-shaped member coupled to said handle portion, said substantially L-shaped member having a downwardly protruding portion;
gripping said handle portion; and
tapping a gaming machine button with said downwardly protruding portion.

7. The method of claim 6 wherein said downwardly protruding portion comprises an outer surface having a shock-absorbent material.

8. The method of claim 7 wherein said shock-absorbent material is rubber.

9. The method of claim 6 wherein a distance from an end portion of said handle portion to said downwardly protruding portion is approximately 10 inches.

10. The method of claim 6 wherein said downwardly protruding portion comprises a substantially flat end portion.
